(19) United States
(12) Patent Application Publication
(10) Pub. No.: US 2019/0068002 A1
(43) Pub. Date: Feb. 28, 2019

(54) Wireless Power System With Display Interference Mitigation

(71) Applicant: Apple Inc., Cupertino, CA (US)

(72) Inventors: Anshi Liang, San Jose, CA (US); Yang Xu, San Jose, CA (US); Rui Zhang, Redwood City, CA (US); Marc J. DeVincentis, Palo Alto, CA (US); Paolo Sacchetto, Cupertino, CA (US)

(21) Appl. No.: 15/891,210

(22) Filed: Feb. 7, 2018

Related U.S. Application Data
(60) Provisional application No. 62/551,729, filed on Aug. 29, 2017.

(51) Int. Cl. H02J 50/60; H02J 50/80; H02J 50/10

(52) U.S. Cl. CPC H02J 50/60; H02J 50/10; H02J 50/80

(57) ABSTRACT

A wireless power system may have a wireless power transmitting device and a wireless power receiving device. The wireless power receiving device may have a display that operates at a frame rate. The wireless power transmitting device may transmit wireless power signals to the wireless power receiving device at an initial frequency. In response to receiving the wireless power signals or in response to a request sent by the wireless power transmitting device, the wireless power receiving device transmits information on the frame rate to the wireless power transmitting device. The wireless power transmitting device uses the initial frequency and the frame rate in determining a safe frequency to use in transmitting wireless signals to avoid or at least reduce interference with the display. The wireless power transmitting device then adjusts the wireless power transmission frequency from the initial frequency to the safe frequency.

This application claims the benefit of provisional patent application No. 62/551,729, filed Aug. 29, 2017, which is hereby incorporated by reference herein in its entirety.

### FIELD

This relates generally to power systems, and, more particularly, to wireless power systems for charging electronic devices.

### BACKGROUND

In a wireless charging system, a wireless charging mat wirelessly transmits power to a portable electronic device that is placed on the mat. The portable electronic device has a coil and rectifier circuitry. The coil in the portable electronic device is used to receive alternating-current wireless power signals from a coil in the wireless charging mat that is overlapped by the coil in the portable electronic device. The rectifier circuitry converts the received signals into direct-current power.

### SUMMARY

A wireless power system has a wireless power transmitting device and a wireless power receiving device. The wireless power receiving device has a display that operates at a frame rate. Frequency adjustments are made by the wireless power transmitting device to avoid interfering with the display.

The wireless power transmitting device transmit wireless power signals to the wireless power receiving device at an initial frequency. In response to receiving the wireless power signals or in response to a request sent by the wireless power transmitting device, the wireless power receiving device transmits the frame rate to the wireless power transmitting device. The wireless power transmitting device uses the initial frequency and the frame rate in determining a safe frequency to use in transmitting wireless signals to avoid interfering with the display. The wireless power transmitting device then changes the wireless power transmission frequency from the initial frequency to the safe frequency so that wireless power is transmitted without creating visual artifacts on the display.

### BRIEF DESCRIPTION OF THE DRAWINGS

FIG. 1 is a schematic diagram of an illustrative wireless charging system that includes a wireless power transmitting device and a wireless power receiving device in accordance with an embodiment.

FIG. 2 is a top view of an illustrative wireless power transmitting device having a charging surface on which a wireless power receiving device has been placed in accordance with an embodiment.

FIG. 3 is a circuit diagram of illustrative wireless power transmitting circuitry and illustrative wireless power receiving circuitry in accordance with an embodiment.

FIG. 4 is a circuit diagram of an illustrative oscillator in accordance with an embodiment.

FIG. 5 is a circuit diagram of an illustrative display in accordance with an embodiment.

FIG. 6 is a flow chart of illustrative operations involved in using wireless power transmitting and receiving devices in accordance with an embodiment.

### DETAILED DESCRIPTION

A wireless power system includes a wireless power transmitting device such as a wireless charging mat. The wireless power transmitting device wirelessly transmits power to a wireless power receiving device such as a wristwatch, cellular telephone, tablet computer, laptop computer, or other electronic equipment. The wireless power receiving device uses power from the wireless power transmitting device for powering the device and for charging an internal battery.

The wireless power transmitting device communicates with the wireless power receiving device and obtains information on the frame rate of a display in the wireless power receiving device. The wireless power transmitting device uses the frame rate to determine a safe wireless power transmission frequency to use in transmitting wireless power to the wireless power receiving device. Use of the safe frequency prevents interference between the wireless power transmitting device and the display.

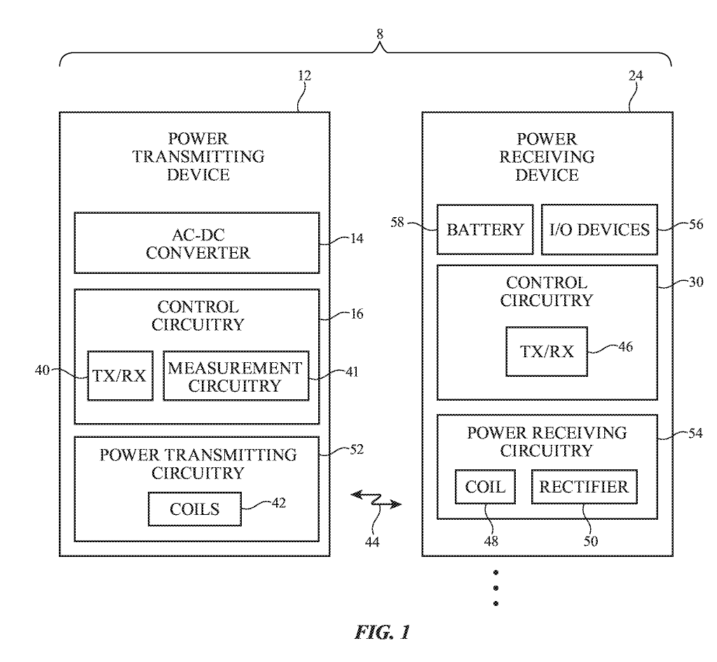

An illustrative wireless power system (wireless charging system) is shown in FIG. 1. As shown in FIG. 1, wireless power system 8 includes a wireless power transmitting device such as wireless power transmitting device 12 and includes a wireless power receiving device such as wireless power receiving device 24. Wireless power transmitting device 12 includes control circuitry 16. Wireless power receiving device 24 includes control circuitry 30. Control circuitry in system 8 such as control circuitry 16 and control circuitry 30 is used in controlling the operation of system 8. This control circuitry may include processing circuitry associated with microprocessors, power management units, baseband processors, digital signal processors, microcontrollers, and/or application-specific integrated circuits with processing circuits. The processing circuitry implements desired control and communications features in devices 12 and 24. For example, the processing circuitry may be used in selecting coils, determining power transmission levels, processing sensor data and other data, processing user input, handling communications between devices 12 and 24 (e.g., sending and receiving in-band and out-of-band data), making measurements, adjusting a wireless power transmission frequency, and otherwise controlling the operation of system 8.

Control circuitry in system 8 may be configured to perform operations in system 8 using hardware (e.g., dedicated hardware or circuitry), firmware and/or software. Software code for performing operations in system 8 is stored on non-transitory computer readable storage media (e.g., tangible computer readable storage media) in control circuitry 8. The software code may sometimes be referred to as software, data, program instructions, instructions, or code. The non-transitory computer readable storage media may include non-volatile memory such as non-volatile random-access memory (NVRAM), one or more hard drives (e.g., magnetic drives or solid state drives), one or more removable flash drives or other removable media, or the like. Software stored on the non-transitory computer readable storage media may be executed on the processing circuitry of control circuitry 16 and/or 30. The processing circuitry may include application-specific integrated circuits with processing circuitry, one or more microprocessors, a central processing unit (CPU) or other processing circuitry.

Power transmitting device 12 may be a stand-alone power adapter (e.g., a wireless charging mat that includes power adapter circuitry), may be a wireless charging mat that is coupled to a power adapter or other equipment by a cable, may be a portable device, may be equipment that has been incorporated into furniture, a vehicle, or other system, or may be other wireless power transfer equipment. Illustrative configurations in which wireless power transmitting device 12 is a wireless charging mat are sometimes described herein as an example.

Power receiving device 24 may be a portable electronic device such as a wristwatch, a cellular telephone, a laptop computer, a tablet computer, an accessory such as an earbud, or other electronic equipment. Power transmitting device 12 may be coupled to a wall outlet (e.g., an alternating current power source), may have a battery for supplying power, and/or may have another source of power. Power transmitting device 12 may have an alternating-current (AC) to direct-current (DC) power converter such as AC-DC power converter 14 for converting AC power from a wall outlet or other power source into DC power. DC power may be used to power control circuitry 16. During operation, a controller in control circuitry 16 may use power transmitting circuitry 52 to transmit wireless power to power receiving circuitry 54 of device 24. Power transmitting circuitry 52 may have switching circuitry (e.g., inverter circuitry formed from transistors) that is turned on and off based on control signals provided by control circuitry 16 to create AC current signals through one or more transmit coils 42. Coils 42 may be arranged in a planar coil array (e.g., in configurations in which device 12 is a wireless charging mat).

As the AC currents pass through one or more coils 42, alternating-current electromagnetic fields (signals 44) are produced that are received by one or more corresponding receiver coils such as coil 48 in power receiving device 24. When the alternating-current electromagnetic fields are received by coil 48, corresponding alternating-current currents are induced in coil 48. Rectifier circuitry such as rectifier 50, which contains rectifying components such as synchronous rectification metal-oxide-semiconductor transistors arranged in a bridge network, converts received AC signals (received alternating-current signals associated with electromagnetic signals 44) from coil 48 into DC voltage signals for powering device 24.

The DC voltages produced by rectifier 50 can be used in powering a battery such as battery 58 and can be used in powering other components in device 24. For example, device 24 may include input-output devices 56 such as a display, touch sensor, communications circuits, audio components, sensors, and other components and these components may be powered by the DC voltages produced by rectifier 50 (and/or DC voltages produced by battery 58).

Device 12 and/or device 24 may communicate wirelessly using in-band or out-of-band communications. Device 12 may, for example, have wireless transceiver circuitry 40 that wirelessly transmits out-of-band signals to device 24 using an antenna. Wireless transceiver circuitry 40 may be used to wirelessly receive out-of-band signals from device 24 using the antenna. Device 24 may have wireless transceiver circuitry 46 that transmits out-of-band signals to device 12. Receiver circuitry in wireless transceiver 46 may use an antenna to receive out-of-band signals from device 12.

Wireless transceiver circuitry 40 can use one or more coils 42 to transmit in-band signals to wireless transceiver circuitry 46 that are received by wireless transceiver circuitry 46 using coil 48. Any suitable modulation scheme may be used to support in-band communications between device 12 and device 24. With one illustrative configuration, frequency-shift keying (FSK) is used to convey in-band data from device 12 to device 24 and amplitude-shift keying (ASK) is used to convey in-band data from device 24 to device 12. Power may be conveyed wirelessly from device 12 to device 24 during these FSK and ASK transmissions. Other types of in-band communications may be used, if desired.

During wireless power transmission operations, circuitry 52 supplies AC drive signals to one or more coils 42 at a given power transmission frequency. The power transmission frequency may be, for example, a predetermined frequency of about 125 kHz, at least 80 kHz, at least 100 kHz, less than 500 kHz, less than 300 kHz, or other suitable wireless power frequency. In some configurations, the power transmission frequency may be tuned. For example, the power transmission frequency may be tuned over a range of about 50-100 kHz to adjust power transmission conditions. In other configurations, the power transmission frequency is essentially fixed and does not vary more than a small amount (e.g., the charging frequency never deviates by more than about 100-1000 Hz or other small amount from its nominal target frequency). In either case, interference with the operation of a display in device 24 can be reduced or eliminated entirely by making additional small adjustments (e.g., less than 100 Hz or other small amount) to the wireless power transmission frequency based on the frame rate of the display.

During wireless power transfer operations, device 12 and device 24 can communicate using in-band and/or out-of-band wireless communications. As an example, while power transmitting circuitry 52 is driving AC signals into one or more of coils 42 to produce signals 44 at the power transmission frequency, wireless transceiver circuitry 40 can use FSK modulation to modulate the power transmission frequency of the driving AC signals and thereby modulate the frequency of signals 44. In device 24, coil 48 receives signals 44. Power receiving circuitry 54 uses the received signals on coil 48 and rectifier 50 to produce DC power. At the same time, wireless transceiver circuitry 46 uses FSK demodulation to extract the transmitted in-band data from signals 44. This approach allows FSK data (e.g., FSK data packets) to be transmitted in-band from device 12 to device 24 with coils 42 and 48 while power is simultaneously being wirelessly conveyed from device 12 to device 24 using coils 42 and 48.

In-band communications between device 24 and device 12 may, as an example, use ASK modulation and demodulation techniques. Wireless transceiver circuitry 46 transmits in-band data to device 12 by using a switch (e.g., one or more transistors in transceiver 46 that are coupled coil 48) to modulate the impedance of power receiving circuitry 54 (e.g., coil 48). This, in turn, modulates the amplitude of signal 44 and the amplitude of the AC signal passing through coil(s) 42. Wireless transceiver circuitry 40 monitors the amplitude of the AC signal passing through coil(s) 42 and, using ASK demodulation, extracts the transmitted in-band data from these signals that was transmitted by wireless transceiver circuitry 46. The use of ASK communications allows ASK data bits (e.g., ASK data packets) to be transmitted in-band from device 24 to device 12 with coils 48 and 42 while power is simultaneously being wirelessly conveyed from device 12 to device 24 using coils 42 and 48.

In some arrangements, in-band communications schemes such as these may be used to support bidirectional communications between device 12 and device 24. In other arrangements, system 8 may support unidirectional in-band communications. For example, ASK communications may be used to transmit in-band data from device 24 to device 12 in a system configuration in which no in-band data is transmitted from device 12 to device 24.

Control circuitry 16 has external object measurement circuitry 41 (sometimes referred to as foreign object detection circuitry or external object detection circuitry) that detects external objects on a charging surface associated with device 12. Circuitry 41 can detect foreign objects such as coils, paper clips, and other metallic objects and can detect the presence of wireless power receiving devices 24. During object detection and characterization operations, external object measurement circuitry 41 can be used to make measurements on coils 42 to determine whether any devices 24 are present on device 12 (e.g., to determine whether to initiate power transmission operations).

In an illustrative arrangement, measurement circuitry 41 of control circuitry 16 contains signal generator circuitry (e.g., oscillator circuitry for generating AC probe signals at one or more probe frequencies, a pulse generator, etc.) and signal detection circuitry (e.g., filters, analog-to-digital converters, impulse response measurement circuits, etc.). During measurement operations, switching circuitry in device 12 may be adjusted by control circuitry 16 to switch each of coils 42 into use. As each coil 42 is selectively switched into use, control circuitry 16 uses the signal generator circuitry of signal measurement circuitry 41 to apply a probe signal to that coil while using the signal detection circuitry of signal measurement circuitry 41 to measure a corresponding response. Measurement circuitry in control circuitry 30 and/or in control circuitry 16 may also be used in making current and voltage measurements.

The characteristics of each coil 42 depend on whether any foreign objects overlap that coil (e.g., coins, wireless power receiving devices, etc.) and also depend on whether a wireless power receiving device with a coil such as coil 48 of FIG. 1 is present, which could increase the measured inductance of any overlapped coil 42). Signal measurement circuitry 41 is configured to measure signals at the coil while supplying the coil with signals at one or more frequencies (to measure coil inductances), signal pulses (e.g., so that impulse response measurement circuitry in the measurement circuitry can be used to make inductance and Q factor measurements), etc. Using measurements from measurement circuitry 41, the wireless power transmitting device determines whether an external object is present on the coils. If, for example, all of coils 42 exhibit their expected nominal response to the applied signals, control circuitry 16 can conclude that no external devices are present. If one of coils 42 exhibits a different response (e.g., a response varying from a normal no-objects-present baseline), control circuitry 16 can conclude that an external object (potentially a compatible wireless power receiving device) is present.

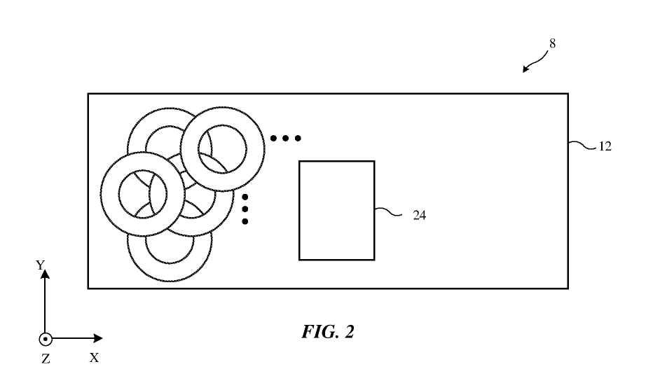

A top view of an illustrative configuration for device 12 in which device 12 has an array of coils 42 is shown in FIG. 2. Device 12 may, in general, have any suitable number of coils 42 (e.g., 22 coils, at least 5 coils, at least 10 coils, at least 15 coils, fewer than 30 coils, fewer than 50 coils, etc.). Coils 42 may be arranged in rows and columns and may or may not overlap each other. If desired, system 8 may be configured to accommodate the simultaneous charging of multiple devices 24. Illustrative operations involved in operating system 8 to provide power wirelessly to a single device 24 are sometimes described herein as an example.

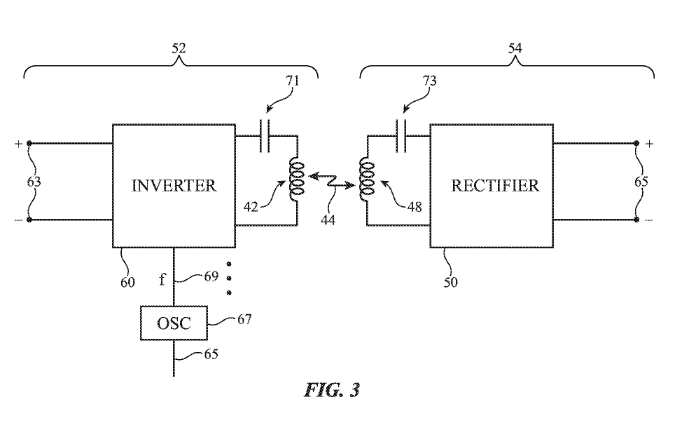

Illustrative circuitry of the type that may be used for forming power transmitting circuitry 52 and power receiving circuitry 54 of FIG. 1 is shown in FIG. 3. As shown in FIG. 3, power transmitting circuitry 52 may include drive circuitry (inverter circuitry) for supplying alternating-current drive signals to coils 42. With one illustrative configuration, the inverter circuitry includes multiple inverter circuits such as inverter 60 of FIG. 3 each of which is controlled by control circuitry 16 of device 12 and each of which is coupled to a respective one of coils 42. Control circuitry 16 can switch selected coil(s) 42 into use by using corresponding inverters 60 to drive signals into the coils.

Each inverter 60 has metal-oxide-semiconductor transistors or other suitable transistors. These transistors are modulated by an AC signal at wireless power transmission frequency f. This AC control signal is produced at the output of oscillator 67 on path 69, which is coupled to the input of inverter 60. The frequency f of the AC signal on path 69 (and therefore the frequency of the drive signal supplied by inverter 60 to coil 42 and the frequency of wireless power signal 44) can be adjusted by control circuitry 16, which supplies a frequency adjustment control signal to control input 65 of oscillator 67. During operation, the AC signal supplied to inverter 60 from oscillator 67 modulates the transistors of inverter 60 so that direct-current power across direct-current power supply input terminals 63 is converted into a corresponding AC drive signal applied to coil 42 via capacitor 71. This produces wireless power signals 44 that are received at coil 48. The AC signals from coil 48 that are produced in response to received signals 44 are coupled to rectifier 50 via capacitor 73 and are rectified by rectifier 50 to produce direct-current output power across output terminals 65. Terminals 65 may be coupled to the load of power receiving device 24 (e.g., battery 58 and other components in device 24 that are being powered by the direct-current power supplied from rectifier 50).

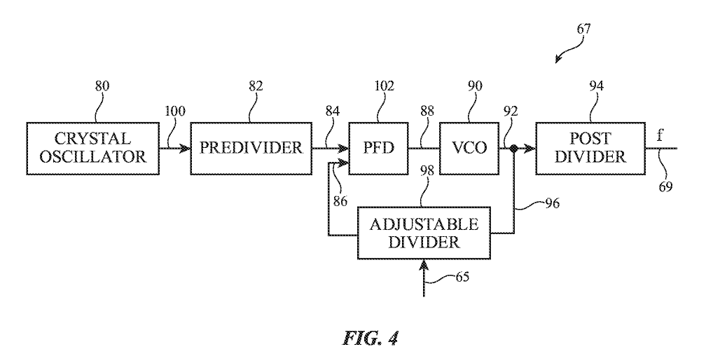

FIG. 4 is a circuit diagram of illustrative circuitry for adjustable oscillator 67. As shown in FIG. 4, circuitry 67 may include a high-frequency oscillator such as crystal oscillator 80. Crystal oscillator 80 produces a stable alternating-current output on path 100 at a reference frequency of 24 MHz or other suitable reference frequency. Pre-divider 82 divides the reference frequency (e.g., by 2 or other suitable value). The output of pre-divider 82 is received on input 84 of phase-frequency detector 102. Phase-frequency detector 102 also receives a feedback signal from the output of an adjustable divider such as fractional programmable divider 98, which forms part of a feedback path from the output of the phase-locked loop.

Phase-frequency detector 102 compares the signals on paths 84 and 86 and generates a corresponding correction signal (sometimes referred to as an error signal) on path 88. Voltage-controlled oscillator 90 supplies an alternating-current output on path 92. During operation, voltage-controlled oscillator 90 receives the correction signal on path 88 and adjusts the frequency on path 92 up or down accordingly. Post divider 94 divides the frequency of the signal on path 92 by a desired amount (e.g., 5000 or other suitable amount) to produce AC drive signals for inverter 60 on path 69 (e.g., AC drive signals at a wireless power transmission frequency of 120-130 kHz, 100-300 kHz, at least 90 kHz, less than 310 kHz, or other suitable frequency.

A feedback path is formed by path 96, fractional programmable divider 98, and input 86. This feedback path is used to feed back the output on path 92 (as divided by divider 98) to the input of phase-frequency detector 102. Fractional programmable divider 98 may divide the frequency of the signal on path 96 by any suitable amount before this signal provided to input 86. As just one example, divider 98 may divide the frequency of the signal on path 96 by about 50. The amount of division performed by divider 98 is adjusted dynamically by control circuitry 16 (e.g., based on control signals applied to input 65). By adjusting the amount of division performed by divider 98 (which need not be limited to integer values), control circuitry adjusts the frequency of the feedback signal applied to input 86 and therefore the frequency f of the AC drive signal on output 69.

Input-output devices 56 of device 24 may include a display. The display may be any suitable type of display (e.g., a liquid crystal display, an electrophoretic display, a microelectromechanical systems display, an organic light-emitting diode display, a display having an array of light-emitting diodes formed from respective crystalline semiconductor dies, etc.). With one illustrative configuration, which may sometimes be described herein as an example, display 14 may be a light-emitting diode display having an array of light-emitting diode pixels (e.g., organic light-emitting diode pixels each having an organic light-emitting diode, pixels formed from light-emitting diodes on respective crystalline semiconductor dies, etc.) or a liquid crystal display. The display displays frames of image data on a pixel array, thereby producing viewable images for a user of device 24. Frames may be displayed at any suitable frame rate. For example, image frames in device 24 may be displayed at a frame rate of 30 Hz to 240 Hz, 50-60 Hz, or other suitable frame rate.

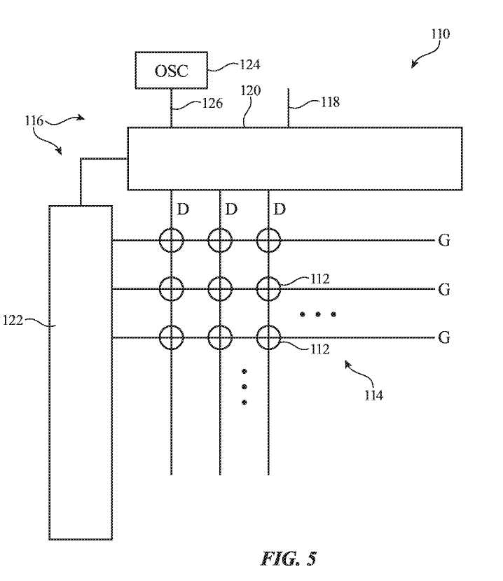

A schematic diagram of an illustrative display for device 24 is shown in FIG. 5. As shown in FIG. 5, display 110 has an array of pixels 112. Each pixel 112 may have a light-emitting diode such as an organic light-emitting diode or a light-emitting diode formed from a crystalline semiconductor die (sometimes referred to as a micro-light-emitting diode), may be an individually adjustable liquid crystal display pixel, etc. Pixels 112 of pixel array 114 may be organized in rows and columns. There may be any suitable number of rows and columns in the array of pixels 112 (e.g., ten or more, one hundred or more, or one thousand or more). Display 110 may include pixels 112 of different colors. As an example, display 110 may include red pixels that emit red light, green pixels that emit green light, and blue pixels that emit blue light.

Pixel array 114 of display 110 displays images for a user in accordance with data and control signals provided to pixel array 114 using display driver circuitry 116. Display driver circuitry 116 may include thin-film transistor circuitry and/or may include one or more integrated circuits. Signal paths such as signal path 118 may couple display driver circuitry 116 to control circuitry 16.

During operation, the control circuitry of device 12 (e.g., control circuitry 16 of FIG. 1) may supply circuitry such as display driver circuitry 116 with information on images to be displayed on display 14. To display the images on display pixels 112, display driver circuitry 120 may supply corresponding image data to data lines D while issuing clock signals and other control signals to supporting display driver circuitry such as gate driver circuitry 122. Gate driver circuitry 122 may produce horizontal control signals (sometimes referred to as gate line signals, scan signals, emission enable signals, etc.) for pixels 112. The horizontal control signals may be conveyed to pixels 112 using horizontal control signal lines such as lines G. There may be one or more horizontal control lines per row of pixels 112. Display driver circuitry such as gate driver circuitry 122 may be located along the edges of display 110 (e.g., along the left edge of display 110 as shown in FIG. 5 and/or along the opposing right edge of display 110). Display driver circuitry such as display driver circuitry 120 may be located above and/or below pixel array 114 or elsewhere in display 110. Other display configurations may be used, if desired. The configuration of FIG. 5 is illustrative.

Oscillator (clock circuitry) 122 supplies an alternating-current signal to display driver circuitry 120 that display driver circuitry 120 uses in providing clock signals to circuitry such as circuitry 122. Oscillator 122 may include a crystal oscillator and phase-locked loop (see, e.g., the illustrative phase-locked loop circuitry of FIG. 4) and/or other oscillator circuitry for producing a stable reference frequency to display driver circuitry 116 on path 126.

During operation, display driver circuitry 20 supplies data signals onto data lines D while display driver circuitry such as gate line driver circuitry 122 issues control signals horizontal lines G in sequence. Frames of image data are loaded in this way, where each frame starts with the loading of data into the first row of pixels 112 and ends with the loading of data into the last row of pixels 112 in array 114. In this way, image frames are displayed on pixel array 114 at a frame rate FR. Frame rate FR may be any suitable value (e.g., at least 25 Hz, at least 30 Hz, at least 50 Hz, at least 60 Hz, less than 240 Hz, less than 120 Hz, etc.). In some arrangements, for example, frame rate FR is close to 60 Hz.

During wireless power transmission, magnetic fields in signals 44 create voltage fluctuations on data lines D at the wireless power transmission frequency f. The voltage fluctuations can give rise to undesirable visual artifacts on display 110 due to interplay (e.g., beat frequency effects) between the voltage fluctuations at frequency f and the rate at which each row of pixels 112 is repeatedly loaded from the data lines (frame rate FR). For example, visual artifacts such as patterns of alternating light and dark bands that run across display 110 may be created.

These undesired visual artifacts are most noticeable when the sampled noise on the data lines (at frequency f) is reinforced each frame (e.g., when the frequency f is an integral multiple of the frame rate) and are minimized when alternating frames of image data experience noise that cancels. Noise cancellation in alternate image frames can be maximized (and visual artifacts minimized) by adjusting frequency f so that frequency f is equal to an integral multiple of frame rate FR plus 0.5. This can be accomplished by obtaining the frame rate FR of device 24 from device 24 using wireless communications (e.g., in-band communications) and adjusting oscillator 67 (FIG. 3) to a suitable wireless power transmission frequency based on the frame rate. Frame rate FR can be programmed into device 24 during manufacturing (e.g., FR can be stored in memory in control circuitry 30), which allows this information to be transferred to device 12 during use of system 8 to provide device 24 with wireless power.

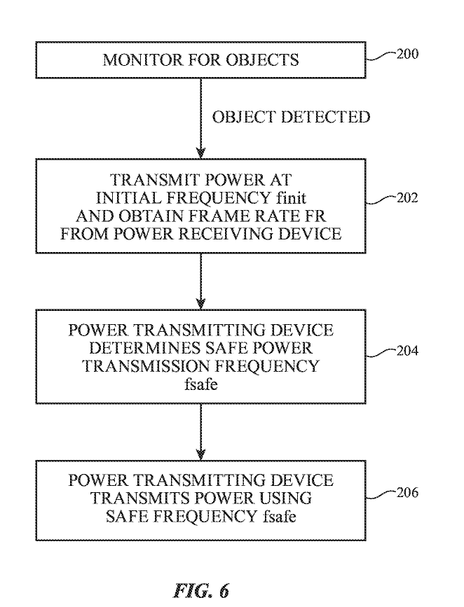

FIG. 6 is a flow chart of illustrative operations involved in operating system 8.

During the operations of block 200, control circuitry 16 may use measurement circuitry 41 to monitor for the presence of external objects. If an external object is detected on a set of one or more coils 42 in device 12 that potentially corresponds to device 24, device 12 can transmit power (signals 44) to device 24 to power device 24 during the operations of block 202. During block 202, control circuitry 16 can supply a frequency control signal to oscillator 67 of wireless power transmitting circuitry 52 that directs wireless power transmitting circuitry 52 to operate at an initial (default) frequency finit (e.g., wireless power transmission frequency f is set to finit).

As power is being transmitted to device 24 during the operations of block 202, device 24 can provide device 12 with frame rate FR. Device 24 may provide the value of frame rate FR to device 12 in response to receipt of wireless power signals 44 (e.g., in a configuration in which device 24 unidirectionally communicates information to device 24 using in-band communications) or device 12 can transmit an in-band request to device 24 that directs device 24 to provide the value of frame rate FR to device 12 via in-band communications. Out-of-band communications may also be used to transfer frame rate FR from device 24 to device 12. In configurations in which device 12 maintains a library of known device types, device 12 can look up the frame rate information in the library based on the received device type information from device 24.

After obtaining frame rate FR from device 24, device 12 determines an appropriate safe frequency fsafe with which to transmit power to device 12 (block 204). With one illustrative configuration, control circuitry 16 is used to determine fsafe using equation 1, where FR is the frame rate display 110 in device 24, and INT is the integer function that produces an integer from its argument (e.g., INT discards the decimal digits from its argument and retains the whole number part of that number).

fsafe=FR*(INT[finit/FR]+OFFSET) (1)

In equation 1, the term OFFSET may have a value that ensures that noise from wireless power transmission will cancel in successive frames. For example, OFFSET may have a value of 0.5. Other non-zero values having a decimal portion of 0.5 (e.g., 0.5 plus an integer) may also be used to form the offset (e.g., fsafe can be determined by adding 1.5 or 2.5 to INT(finit/FR) or by adding other such offsets less than 10, less than 100, at least 2, etc. If desired, small integer values for OFFSET (e.g., OFFSET=1) may be used.

Consider, as an example, a scenario in which frequency finit is 130 kHz and in which frame rate FR is frame is 59.9 Hz. In this scenario, INT(finit/FR) is 2170 and fsafe is 130,013 Hz. The difference between finit (130,000 Hz) and fsafe (130,013 Hz) in this example is 13 Hz. This frequency adjustment is small and does not have a significant impact on wireless charging performance. In variable frequency systems (e.g., systems in which frequency f is tuned over a relatively wide range of 100-300 kHz, etc.), these tuning adjustments may be made after coarse tuning of the wireless power transmission frequency (e.g., to adjust power transfer) or as part of a coarse tuning operations. In fixed frequency systems, finit can be adjusted by the small offset amount after FR has been obtained from device 24.

After determining the safe wireless power transmission frequency fsafe, control circuitry 16 supplies a corresponding control signal to input 65 of oscillator 67 so that wireless power transmitting circuitry 52 transmits wireless power signals 44 to device 24 at frequency fsafe (block 206). By using fsafe to transmit wireless power, display 110 of device 24 can be used without suffering significant interference from wireless power signals.

The foregoing is merely illustrative and various modifications can be made to the described embodiments. The foregoing embodiments may be implemented individually or in any combination.

What is claimed is:

1. A wireless power transmitting device configured to provide wireless power signals to a wireless power receiving device that has a display configured to operate at a frame rate, comprising:
wireless power transmitting circuitry configured to wirelessly transmit the wireless power signals to the wireless power receiving device at a frequency;
control circuitry configured to adjust the frequency based on the frame rate.

2. The wireless power transmitting device of claim 1 wherein the control circuitry is configured to receive the frame rate wirelessly from the wireless power receiving device.

3. The wireless power transmitting device of claim 2 wherein the control circuitry is configured to:
transmit a request to the wireless power receiving device; and
receive the frame rate from the wireless power receiving device in response to the request.

4. The wireless power transmitting device of claim 1 wherein the control circuitry is configured to:
receive the frame rate from the wireless power receiving device without sending a request for the frame rate to the wireless power receiving device.

5. The wireless power transmitting device of claim 1 wherein the control circuitry is configured to:
use the wireless power transmitting circuitry to transmit the wireless power signals to the wireless power receiving device at an initial frequency before receiving the frame rate from the wireless power receiving device; and
receive the frame rate after using the wireless power transmitting circuitry to transmit the wireless power signals to the wireless power receiving device at the initial frequency.

6. The wireless power transmitting device of claim 5 wherein the control circuitry is configured to:
use the frame rate to adjust the frequency with which the wireless power transmitting circuitry transmits the wireless power signals to the wireless power receiving device from the initial frequency to a safe frequency that exhibits reduced interference with the display relative to the initial frequency.

7. The wireless power transmitting device of claim 6 wherein the control circuitry is configured to determine the safe frequency by dividing the initial frequency by the frame rate to produce a number with decimal digits, discarding the decimal digits from the number, adding an offset value, and then multiplying by the frame rate.

8. The wireless power transmitting device of claim 1 wherein the wireless power transmitting circuitry comprises a coil, an inverter couple to the coil, and an oscillator that provides alternating-current signals to the coil at the frequency and wherein the control circuitry is configured to adjust the frequency by adjusting the oscillator.

9. The wireless power transmitting device of claim 8 wherein the oscillator comprises a phase-locked loop having a feedback path with a fractional programmable divider and wherein the control circuitry is configured to adjust the frequency by adjusting the fractional programmable divider.

10. A wireless power transmitting device configured to provide wireless power signals to a wireless power receiving device that has a display, comprising:
wireless power transmitting circuitry configured to wirelessly transmit the wireless power signals to the wireless power receiving device at a first frequency; and
control circuitry configured to:
receive information from the wireless power receiving device while the wireless power signals are being transmitted to the wireless power receiving device at the first frequency; and
based on the received information, adjust the wireless power transmitting circuitry to reduce interference with the display by wirelessly transmitting the wireless power signals to the wireless power receiving device at a second frequency that is different than the first frequency.

11. The wireless power transmitting device of claim 10 wherein the information from the wireless power receiving device comprises a frame rate at which image data is displayed on the display and wherein the control circuitry is further configured to adjust the wireless power transmitting circuitry to wirelessly transmit the wireless power signals to the wireless power receiving device at the second frequency based on the frame rate.

12. The wireless power transmitting device of claim 11 wherein the second frequency is computed at least partly by discarding decimal digits from a number determined by dividing the frame rate into the first frequency.

13. The wireless power transmitting device of claim 11 wherein the wireless power transmitting circuitry has a phase-locked loop that produces an output signal, wherein the control circuitry is configured to adjust the phase-locked loop to adjust the wireless power transmitting circuitry.

14. The wireless power transmitting device of claim 11 wherein the wireless power transmitting circuitry includes a coil and wherein the control circuitry is configured to receive the frame rate using the coil.

15. The wireless power transmitting device of claim 11 further comprising measurement circuitry configured to detect external objects on the wireless power transmitting device, wherein the control circuitry is configured to direct the wireless power transmitting circuitry to transmit the wireless power signals at the first frequency in response to detection of the wireless power receiving device with the measurement circuitry.

16. A method of transmitting wireless power signals from a wireless power transmitting device having control circuitry and wireless power transmitting circuitry to a wireless power receiving device having a display that operates at a frame rate, comprising:
with the wireless power transmitting circuitry, transmitting the wireless power signals at a first frequency; and
with the control circuitry, receiving the frame rate from the wireless power receiving circuitry;
with the control circuitry, determining a second frequency that is different than the first frequency based on the received frame rate; and
with the wireless power transmitting circuitry, transmitting the wireless power signals at the second frequency determined by the control circuitry.

17. The method of claim 16 further comprising:
transmitting a request for the frame rate to the wireless power receiving device with the control circuitry.

18. The method of claim 16 wherein receiving the frame rate from the wireless power receiving device further comprises:
receiving the frame rate from the wireless power receiving device in response to transmitting the wireless power signals to the wireless power receiving device with the wireless power transmitting circuitry at the first frequency.

19. The method of claim 16 wherein determining the second frequency comprises determining the second frequency based on the frame rate and the first frequency.

20. The method of claim 16 wherein the wireless power transmitting circuitry comprises a coil and wherein receiving the frame rate comprises receiving the frame rate using the coil.
